(19) United States
(12) Patent Application Publication
(10) Pub. No.: US 2003/0213115 A1
(43) Pub. Date: Nov. 20, 2003

(54) Dual layer handle

(76) Inventor: Roland Knapton, Fridley, MN (US)

Correspondence Address: MARK A. LITMAN & ASSOCIATES, P.A., York Business Center, Suite 205, 3209 W. 76th St., Edina, MN, 55435, US

(21) Appl. No.: 10/389,704

(22) Filed: Mar. 13, 2003

Related U.S. Application Data
(60) Provisional application No. 60/363,946, filed on Mar. 13, 2002.

(51) Int. Cl. B23P 11/00

(52) U.S. Cl. 29/428

(57) ABSTRACT

A method of applying a cover element to an elongated support comprises sliding the cover element over the elongated support by force, the cover element having an interior surface on at least one layer facing and adjacent to the elongated support, and the interior surface having a Shore A hardness of less then 55. This support with a cover element may be a handle, and other layers may be easily positioned over the cover element.

### RELATED APPLICATIONS

This Application claims priority from U.S. Provisional Application Serial No. 60/363,946 filed on Mar. 13, 2002.

### BACKGROUND OF THE INVENTION

1. Field of the Invention

The field of the invention is systems for attaching functional elements to tubes or tube-like support. In particular, the invention relates to grips and handles such as handlebar grips and the invention relates more particularly to handlebar grips which are held to the handlebar in such a way that they are stable, cannot be easily removed during normal use, do not turn during use, yet can be removed cleanly for subsequent replacement. Such grips or handlebar grips may be used on bicycles, pogo-sticks, fishing poles, golf clubs, all-terrain vehicles (ATVs), watercraft and snowmobiles.

2. Background of the Art

Grips and handlebar grips are used in a wide range of systems, including tools and vehicles. The exterior of the grips may vary significantly in properties, depending upon the physical or aesthetic needs of the system. For example, on mountain bikes, grips are preferably soft on the outside so that they can be held without irritating the rider's hands over rough terrain. Grips on golf clubs must provide good friction to hands, be comfortable, yet not shift alignment when subjected to torque or other forces. Grips on various vehicles must display a wide range of properties from water-resistance, friction properties, weather resistance, temperature change resistance, and the like.

The use of grips for vehicles, tools, golf clubs and other sporting implements of various designs and configurations is known in the prior art. More specifically, grips of various designs and configurations heretofore devised and utilized for the purpose of rendering such grips more comfortable and more functional are known to consist basically of familiar, expected and obvious structural configurations, notwithstanding the myriad of designs encompassed by the crowded prior art which have been developed for the fulfillment of countless objectives and requirements. Each type of grip is individually designed, from inside to outside, and there is very little that can be done to provide a uniform technique to their application. For example, each type of grip requires unique adhesives that must tolerate the extremes of use, which might even include resistive heating elements on handlebars for snowmobiles. The style and content of grips covers a very wide range.

By way of example, the prior art in U.S. Pat. No. 4,261,567 to Uffindell discloses a hand grip for a hand-held implement, e.g., a golf club, that consists of a rigid cap and a one-piece flexible foam tubular sleeve. The cap is structured to cooperate with the implement's handle shaft for locating and retaining the grip on that shaft, and for protecting the end of the shaft and the outer end of the foam sleeve. The one-piece flexible foam sleeve, preferably with an outer skin thereon to resist abrasion, provides a cushioned grip to the user. A method is also provided by which the rigid cap and foam sleeve grip are fabricated.

U.S. Pat. No. 4,338,270 to Uffindell discloses a method of fabricating a composite foam hand held implement grip. A hand grip for a hand-held implement, e.g., a golf club that consists of a rigid cap and a one-piece flexible foam tubular sleeve. The cap is structured to cooperate with the implement's handle shaft for locating and retaining the grip on that shaft, and for protecting the end of the shaft and the outer end of the foam sleeve. The one-piece flexible foam sleeve, preferably with an outer skin thereon to resist abrasion, provides a cushioned grip to the user. A method is also provided by which the rigid cap and foam sleeve grip are fabricated.

U.S. Pat. No. 4,639,029 to Kolonia discloses a tool handle. A tool handle comprises a composite structure including a core member having a molded plastic outer coating over the core member, the molded plastic composite structure has a socket end, and intermediate section and a butt end. The socket end includes a substantially circular outside diameter for insertion into a socket portion of the tool on which the handle fits. The intermediate section is oval-shaped in cross-section along substantially the entire length thereof and has a transition portion connecting the circular socket end to the oval-shaped intermediate cross-section. The oval-shaped cross-section is effective to facilitate handling of the tool when the socket end is inserted into the socket portion of the tool. Particular features of the invention are directed to various specifically shaped core members, socket ends and butt ends. Other specific features of the invention are directed to the manner in which the tool handle is connected in a socket portion of a tool or with a shank portion of a tool. The tool handle of the invention is particularly useful with hand tools such as shovels, spading forks, pitchforks and the like.

U.S. Pat. No. 4,919,420 to Sato discloses a grip of a golf club and a manufacturing method thereof. A grip of a golf club according to the present invention prevents slipping, when the grip is grasped by a hand opposite to a whip hand, by applying an area having a plurality of projections to the are of the grip corresponding to the respective bases of the middle finger, the ring finger and the little finger of the palm of the hand opposite to said whip hand and to the palm located on the extension of the neighborhood of the base of the little finger of said palm. Also, since there is an area where a plurality of projections or dents are formed being separated independently one by one. Accordingly, when the whole of the element body of the grip is ground from the surface in a uniform depth, the fiber is exposed in the area having a plurality of plane portions and the fiber is not exposed in the area having a plurality of jogs. In this area where the fiber is exposed, a moderate non-slip effect is obtainable and soft grip feeling is presented.

U.S. Pat. No. 4,941,232 to Decker discloses a slip resistant, cushioning cover for handles. A slip-resistant, flexible, cushioning wrap for a handle comprising a laminate suitable for covering the handle. The laminate has a base layer of cushioning, non-absorbent closed-cell foam having an outer layer of washable, grip-enhancing, random and open-cell foam laminated to one side and having a pressure sensitive adhesive applied to the other side. The laminate may be formed as a sheet or a tube. A sheet of laminate may be cut to conform to the contours of the handle and then wrapped about the handle with the edges either overlapping of abutting. A tube of laminate may also be formed to fit the contours of the handle.

U.S. Pat. No. 4,953,861 to Nakanishi discloses a ball hitting sports tool. A ball hitting sports tool has a ball hitting part and a grip part which is integrated with the ball hitting part through a stem and at least one of the ball hitting part, stem and grip part is provided with a buffer part in which a gel material with a penetration value of approximately 50 to 200 is used as a buffer material.

U.S. Pat. No. 4,964,192 to Marui discloses a multiple radius grip. A cushioned grip having a unitary tubular-shaped body portion with an asymmetrical off-center cross-sectional shape. The asymmetrical off-center shape provides increased cushioning on portions thereof while retaining a moderate sized circumference. The asymmetrical cross-sectional shape provides a first portion having a first thickness of cushioning material, a second portion having a second lower thickness of cushioning material and a third portion of further reduced thickness of cushioned material. The third portion of cushioning is provided with a flat surface to provide a positive and solid feel to the fingers while grabbing the grip. The center's curvature defined by the outside of the cross-sectional shape of the grip is displaced from the center of the inside portion which is generally circular and adapted to receive a hard round member such as a bicycle handlebar to be cushioned. The cushioning thickness may vary from a relatively small value at one end of the grip to a maximum in a central region and reducing again to a smaller thickness at the other end to provide a varying circumference for different size hands.

U.S. Pat. No. 4,984,793 to Chen discloses a racket handle cap of a pliant material in single piece injection molded construction and comprises an opening at one end therefrom elongatedly extending along a grip portion to a flaring section to define an internal cavity, an adhesive tape and a plurality of counter weights. The grip portion has a plurality of oval circulation vents and circular air circulation vents which are respectively formed in rows for eliminating the air therethrough by inserting the handle part of a racket frame thereto. The counter weights respectively conform in shape with the oval circular air circulation vents for defining their optional and removable insertion to the oval and circular air circulation vents, whereby the weight adjustment and distribution of said racket handle cap being achieved.

U.S. Pat. No. 5,042,804 to Uke discloses a hand grip for sporting equipment or tools. A handle grip for fitting on the handle shaft of a sporting implement or tool, for example a racket or bat, comprises an elongate sleeve of elastomeric material having an internal surface for fitting over the handle shaft and an outer, gripping surface for gripping by the user's hand. The grip has indentations on at least one of its inner and outer surfaces which extend over part of the surface area to provide regions of varying softness. The softness is provided by the thinned out or indented regions bending or collapsing under load against the hand.

U.S. Pat. No. 5,088,734 to Glava discloses an attenuating handle for recreational and work implements. A hand-operated implement, which is a shock-producing or vibration-producing implement, has an attenuating handle. The implement has a handle attached to the implement, which handle has a central core, a gripping surface and a gel shock- or vibration-absorbing material positioned adjacent to or recessed in the core and under the gripping surface, wherein the gel shock- or vibration-absorbing material is a gel having a cone penetration between about 100 and 350 (10-1 mm) and an ultimate elongation of at least 100 percent and wherein the thickness of the gel shock- or vibration-absorbing material is sufficient to substantially maintain a shock- or vibration-absorbing separation between the core and at least a portion of the gripping surface, provided that the thickness of the gel shock- or vibration-absorbing material is less than that which interferes with the use of control of the implement, thereby absorbing the shock or vibration produced by the implement without significantly changing the operating control characteristics of the implement. Also disclosed is a method of attenuating shock and vibration in a handle of an implement.

U.S. Pat. No. 5,261,665 to Downey discloses a golf club grip formed of a plurality of materials and method of manufacture thereof. The golf club grip is formed of a hollow, inner socket and an outer jacket produced from different charges of thermoplastic rubber. The socket and jacket differ in stiffness characteristics, colors, or both stiffness and color. The outer jacket is molded onto the socket and bonded thereto throughout the surface of contact therebetween. The torsional stress on the jacket is transmitted to and resisted by the inner socket through the bonding that occurs throughout the interface between the jacket and the socket. Preferably, the socket has an inner socket core portion with a plurality of radially projecting protrusions. The structure of the jacket laterally surrounds the protrusions so that the outermost surfaces of the protrusions are exposed. The golf club grip is produced from a pair of identical mounting cores which are rotated between a pair of molding dies. The sockets are first produced on one mounting core in a first die, and the first mounting core with the socket thereon is cyclically moved into the second die. While the jacket of the golf club grip of the invention is being molded onto the socket just produced in the first die, a new socket is concurrently produced on the second mounting core, which has been moved into the first die.

U.S. Pat. No. 5,322,290 to Minami discloses a golf club grip. A golf club grip has a double-layer structure comprising an inner layer and an outer layer laminated on the outer surface of the inner layer. One of the inner and outer layers is made of a first material, while the other layer is made of a second material. The first material has an elasticity which is higher than that of the second material so that the first material is more readily elastically deformable than the second material, while the second material has a viscoelasticity which is higher than that of the first material.

Various designs have been patented in an attempt to provide a securely held soft grip. One such design is shown in the Kuipers, et al. U.S. Pat. No. 5,280,735. This patent shows a two-piece slip-resistant grip which has an outer nylon lattice housing member with two end clamps. This lattice and end clamp assembly is placed over a softer inner sleeve which extends through the openings in the lattice and is clamped in place by the end cap and flanged end. This assembly is limited to a design where the hand contacting portion is in the shape of diamonds which pass through the lattice. Also, this grip results in the soft inner portion contacting the handlebar and with extended time the soft portion tends to form a bond with the handlebar and is very difficult to remove.

U.S. Pat. No. 3,344,684 to Steere, Jr., et al., shows a handlebar grip which has an inner portion with a transparent or translucent outer portion adhered thereto. The inner portion is slipped on the handlebar without any tightening means. Another two-part grip is shown in U.S. Pat. No. 4,416,166 to Jannard, et al. which has a two-part grip having an outer sleeve fitted over an inner sleeve. These two parts are interlocked by their matching designs.

U.S. Pat. No. 4,535,649 shows a foam surfaced handlebar grip which has a foam sleeve which is held over a hard polymer tube by an end cap and a coupling member. A cork handlebar grip is shown in U.S. Pat. No. 605,626 to Blanchard, Jr. This patent utilizes a slotted tapered pipe which has a nut at each end which captures the cork grip portion.

Hand grips provide a location for a motorcycle rider to engage and steer the handlebars of a motorcycle while riding. In addition to facilitating steering of the motorcycle, the hand grips typically control the throttle of the motorcycle. For both steering and throttle control functions, it is important for the rider to have secure frictional engagement of the hand grips. In this regard, many motorcycle hand grips are made from high friction resilient material, such as rubber. Resilient materials also provide vibration damping to isolate the rider's hands from the shocks and vibrations transmitted through the handlebars.

To enhance the aesthetics of resilient hand grips, some designers include a metal tubular member surrounding a resilient member. The tubular member includes a plurality of openings, and the resilient member includes a plurality of raised portions that are aligned with and extend through the openings. The exposed portion of the tubular member can be chrome plated to provide desired aesthetic effects. The raised portions of the resilient member enhance the friction between the rider's hands and the hand grips. These hand grips are produced by designing the resilient member so that it is radially collapsible and insertable into the tubular member. The resilient member is inserted into the tubular member until the raised portions are aligned with and protrude through the openings.

Hand grips of the above-described type provide desired aesthetics while still providing good frictional characteristics. However, these hand grips can be difficult to manufacture. For example, insertion of the resilient member into the tubular member requires aligning the two members, collapsing the resilient member, and inserting the resilient member into the tubular member until the raised portions are aligned with the openings. These steps can be time-consuming and difficult due to the high-friction characteristics of the resilient member. In addition, because the resilient member must be forced into the tubular member, the height of the raised portions is limited to some extent.

U.S. Pat. No. 5,823,069 providing a method of making a hand grip that does not require insertion of a tubular resilient member into a tubular member. Instead, the present invention molds the resilient material to the tubular member when the resilient material is in a fluid state. The resilient material can then be cured, thereby resulting in the desired hand grip. By virtue of the present invention, there is no need to force a tubular elastomeric member into a tubular member. In addition, since the elastomeric member is molded to the tubular member, the raised portions can be higher than prior art devices, and can overlap the outer surface of the tubular member to provide enhanced aesthetics and improved coupling of the elastomeric member to the tubular member. In general terms, the method includes the steps of positioning within a mold cavity a tubular member having a sidewall with at least one opening in the sidewall, and injecting fluid resilient material into the cavity and between the tubular member and a core whereby a portion of the liquid resilient material flows through the opening to form a raised portion that protrudes through the opening in the tubular member, and solidifying (e.g., cooling) the resilient material. In another aspect, the present invention is directed to a hand grip (e.g., for a motorcycle) that can be produced according to the method described above. In general terms, the hand grip includes a tubular member (e.g., a metallic material) defined by a sidewall having inner and outer surfaces, at least one opening formed in the sidewall, and a tubular resilient member positioned at least partially within the tubular member. The resilient member includes a raised portion that protrudes through the opening in the tubular member and extends over the periphery of the opening and onto the outer surface of the tubular member adjacent the opening (e.g., around substantially the entire perimeter of the opening). By virtue of this design, the resilient member is mechanically coupled to the tubular member.

U.S. Pat. No. 6,263,759 is for a handlebar grip assembly removably attached near an end of a handlebar. The handlebar has a pair of grip receiving lengths adjacent each end. A handlebar grip assembly is removably affixed about each of the grip receiving lengths of the handlebar. The handlebar grip assembly comprises an inner rigid shell having an inner surface to slide over one of the pair of grip receiving lengths of the handlebar. At at least one of the ends the rigid shell has a lengthwise protrusion extending outwardly from the inner surface and radially outwardly to form a curved protrusion from the at least one end of the rigid shell. An outer flexible grip has an inner surface affixed to the outer surface of the inner rigid shell and has a soft preferably textured outer surface which is gripped by the rider. At least one rigid clamp has an inner gripping surface into which is formed at least one shell protrusion receiving recess and the rigid clamp has means for tightening the clamp against the handlebar outer surface and against the at least one lengthwise protrusion sufficiently so that the clamp when tightened will hold the handlebar grip assembly in a non-turning manner on the handlebar. The clamp also has means for loosening the clamp from the handlebar so that the handlebar grip assembly can be removed from the handlebar. Preferably, there are two protrusions at each end of the handlebar of the rigid shell of the handlebar to securely hold the handlebar grip assembly to the handlebar.

U.S. Pat. No. 6,392,209 describes a flat heating element that includes a thin resistance layer containing an electro-conductive polymer and at least two electrodes arranged on one side of the resistance layer at a distance from each other. The polymer has an intrinsic electric conductivity caused by metal dopant(s).

U.S. Pat. No. 6,5216,142 describes an internal hating element for pipes and tubes. Thermal conducting fillers are used in electrically insulative coatings to conduct heat from the resistance heating elements.

### SUMMARY OF THE INVENTION

An at least two-component coaxial tube is used to secure itself or other elements to support tubes, such as handles, grips, handlebars, railings, and the like. The at least two-component coaxial tube has an inner layer that has a Shore A hardness of less than 55 and the exterior layer has a Shore A hardness of at least 65. The coaxial tube is preferably coextruded, and the tube may be easily slid onto a support surface (preferably with a volatile liquid as a lubricant), yet becomes securely fixed to the support surface so that it cannot be easily slid off the surface. The fixed relationship tends to be pressure dominated, and even though the inner surface may have a tacky feel, the fixed relationship is not primarily adhesive securement, so that the layer can be cut off the support surface without leaving substantial residues from the inner layer on the support surface.

### BRIEF DESCRIPTION OF THE FIGURES

FIG. 1 shows a coaxial tube construction according to one embodiment of the invention.

### DETAILED DESCRIPTION OF THE INVENTION

The hardness testing of plastics is most commonly measured by the Shore (Durometer) test or Rockwell hardness test. Both methods measure the resistance of the plastic toward indentation. Both scales provide an empirical hardness value that doesn't correlate to other properties or fundamental characteristics. Shore Hardness, using either the Shore A or Shore D scale, is the preferred method for rubbers/elastomers and is also commonly used for ‘softer’ plastics such as polyolefins, fluoropolymers, and vinyls. The Shore A scale is used for ‘softer’ rubbers while the Shore D scale is used for ‘harder’ ones.

The Shore hardness is measured with an apparatus known as a Durometer and consequently is also known as ‘Durometer hardness’. The hardness value is determined by the penetration of the Durometer indenter foot into the sample. Because of the resilience of rubbers and plastics, the hardness reading my change over time—so the indentation time is sometimes reported along with the hardness number. The ASTM test method designation is ASTM D2240 00. Related methods include ISO 7619 and ISO 868; DIN 53505; and JIS K 6301, which was discontinued and superceded by JIS K 6253.

The results obtained from this test are a useful measure of relative resistance to indentation of various grades of polymers. However, the Shore Durometer hardness test does not serve well as a predictor of other properties such as strength or resistance to scratches, abrasion, or wear, and should not be used alone for product design specifications.

One significantly labor-intensive step in manufacturing of devices such as bicycles, motorcycles, snowmobiles, tools and the like where there are sections that are to be hand held is the application of a handle or cover onto the device. These covers or grips are usually applied by hand, with adhesive applied between the layers. The adhesive application can be messy and expensive, and the need for cleaning operations on the device because of flowing adhesive adds to the expense of hand applications.

Molding of layers or grips removes much of the incremental cost of hand application, but molding can only be performed during manufacture or by siting expensive equipment at distribution centers. The use of toggles, clamps, snaps and inserts to secure the covers tends to provide covers that can be too easily removed, that tend to shift on the support surface, or where the connecting elements too readily snap or break during extremes of weather or other physical conditions.

It has been found that an at least two-component coaxial tube is used to secure itself or other elements to support tubes, such as handles, grips, handlebars, railings, and the like. The at least two-component coaxial tube has an inner layer that has a Shore A hardness of less than 55 and the exterior layer has a Shore A hardness of at least 65. The coaxial tube is preferably coextruded, and the tube may be easily slid onto a support surface (preferably with a volatile liquid as a lubricant), yet becomes securely fixed to the support surface so that it cannot be easily slid off the surface. The fixed relationship tends to be pressure dominated, and even though the inner surface may have a tacky feel, the fixed relationship is not primarily adhesive securement, so that the layer can be cut off the support surface without leaving substantial residues from the inner layer on the support surface. A third layer (or more layers), provided as a top layer or additional layer over the layer having the Shore A hardness of at least 65 may also be present. This is particularly desirable where that top layer provides a specific function, including such functions as resistance heating, cushioning, vibration dampening, gripping friction, thermal insulation, and the like.

The preferred embodiment of the invention may be generally described in the following non-limiting and exemplary terms. An elongated support has an at least dual layer cover over at least a portion of an outer surface of the elongated support. The at least dual layer cover comprises a first polymeric layer in non-adhesive contact with the outer surface of the elongated support. The first polymeric layer has a Shore A hardness of less then 55. A second polymer layer of the at least dual layer construction comprises a polymer having a Shore A hardness of at least 65 adjacent to the first polymeric layer and secured to the first polymer. This securement may be effected by an adhesive or fusion, particularly fusion caused by coextrusion of the two polymers in adjacent coaxial form. A resist heating element may be secured to an exterior surface of the second polymer layer. The preferred construction uses a metal elongate tube, especially in the format of a handle or grip as are used on vehicles such as motorcycles and skimobiles.

The invention also comprises a method of applying a cover element to an elongated support having a uniform cross-section. A preferred embodiment of the method comprises sliding the cover element over the elongated support by force. The force is provided with a significant component parallel to an axis of the elongate support in the direction along which the cover element is to slide. The cover element has an interior surface on at least one layer facing and adjacent to the elongated support. The interior surface has a Shore A hardness of less then 55. The cover element preferably comprises at least two layers, an at least one inner layer having a Shore A hardness less then 55 to provide the sliding friction forces and securing forces. A second polymer layer over the at least one inner layer is an adjacent layer secured to the at least one layer, the adjacent layer having a Shore A hardness of at least 65. The preferred elongate support to be used in the method comprises a metal support. The method is best practiced where the support comprises a fairly uniform cross-section. By fairly uniform it is meant that a circumference of the cross-section does not change by 10% from one end of the cover element to the other, preferably less then 7%, preferably less then 4%, and most preferably less then 2% or less then 1% over a 10 cm length of the cover element. The method is particularly useful where the tube comprises a handle or grip. The cover element may be first applied and the gripping surface, heating surface, vibration damping surface or other overlay may then be applied over the secure cover element. The overlay may be secured by any convention method, including adhesion, fusion, stapling or the like.

The method may use a volatile liquid, which is placed between the cover element and the elongated support during sliding. The volatile liquid reduces the friction during application, but then readily dissipates or volatilizes (even at standard conditions), leaving the cover element secured to the support. The change in the force needed to slide the cover element onto the support as compared to the force needed to slide the cover element off the support can change very rapidly and very dramatically. For example, a force needed to remove the cover element after it has been applied to the elongated support for at least 4 hours at 20° C. and 50% relative humidity may be at least four times greater then the force used to slide the cover element over the elongated support. It may be five, six, seven, eight, nine or ten or more times greater over this interval and with those conditions. The layer having a surface with a Shore A hardness of less then 55 may, by way of non-limiting example, comprise a polymer selected from the group consisting of polyesters, polyolefins, polysilicone resins, polyamides, polyvinyl resins, polyurethanes, polycarbonates, and polysulfones.

The coaxial tube has the two layers firmly secured to each other by physio/chemical means. The layers, when coextruded, which is the preferred method of manufacture, are fused to each other. The layers, with an exemplary 3.8 cm outer diameter (OD), a 1.5 mm external layer, 1.5 mm internal layer, and 3.5 cm inside diameter (ID), cannot be separated with 100 pounds of linear force. An adhesive may also be used between the two layers to secure them, although this would be a more costly method of manufacture. The coaxial tube may be the final grip itself, or may be a connector to an insert that covers the tube or the tube is fitted/embedded within a grip. The tube may then be adhesively secured to the grip (which is a much less exacting and therefore less expensive attachment than is the attachment to the support). The coaxial tube is first constructed, then slid over the support surface, the interior cross-section of the inside diameter of the tube generally corresponding to the shape of the support (e.g., circular cross-section, oval cross-section, ellipsoidal cross-section, rounded edge polygon, etc.). It is useful to provide a volatile lubricant, such as a liquid on the support or in the tube to assist sliding, with the lubricant being in-part pushed off the surface and then evaporating from the edges of the tube. Water will often be sufficient, although more volatile organic liquid materials such as alcohols, ketones and the like may also be used with facility. Heavier oils are not preferred, as they are not sufficiently volatile to be removed from the surface and will assist removal of the coaxial tube greatly.

The electrical leads to a resistive heating element may be any lead that is durable and effective. Metal leads, braided metal leads, and even flat leads are useful. It is preferred that the leads be coextruded into the resist layer or they may be fused to the resist layer or embedded into the resist layer by pressing and heating.

The composition of each of the two layers may be the same or different, as long as the physical properties recited above are maintained for the practice of the invention. The two layer (the at least two layer) construction provides unique capability for applying covers to handles or grips. The element can be applied to strongly fit and secure the two layer element to handles and then other layers or overlay components may be used with the applied two layer covers. Adhesives can be more readily and efficiently used with the already applied two layer cover element or be applied at the same time as the two layer cover element (as with the element already inserted within a heating grip with the adhesive wet or already fully hardened between the cover and the overlay component). The efficiency and ease comes from the fact that the inner layer can be easily applied by methods (later discussed in greater detail) that require little initial force to apply the two layer cover element, yet that element will requires extreme forces to remove it within minutes of application, without the use of adhesives or high energy treatments or thermal treatments to secure the two layer cover element to the substrate. The two layers may be of the same or different chemical classes of polymers. General classes that can be modified or compounded by those skilled in the polymer art to have the desired properties generally include thermoplastic polymers, elastomers, and thermoset polymers. As a non-exclusive list of classes of polymers that may be used are extrudable or castable polymers and polymers such as polyester resins (e.g., polyethylene terephthalate, polyethylene naphthalate and comonomers thereof), polyolefin resins (e.g., polyethylene, polypropylene, polystyrene, polyisoprene, polybutadiene and copolymers thereof, as with acrylonitile as a copolymer), polyamides, polyethers, silicone resins (e.g., polydimethylsiloxanes, poly(methlyphenylsiloxane)), polyfluorinated polymers, polyvinyl resins, polycarbonates, polysulfones, polyurethanes, their copolymers (including block and graft copolymers) and blends and the like.

A preferred method of applying the grip or the electrically heated grip to a cylindrical support comprising applying a volatile liquid between the inner surface and the cylindrical support, sliding the grip onto the cylindrical support by a first force, and evaporating said volatile liquid so that the grip cannot be slid off the cylindrical support except at least by a second force that is 20 kg greater then the first force. The volatile liquid may be applied to the surface (outer surface) of the cylindrical support or preferably on the inner surface of the sleeve (by spraying, wiping, dipping or other application means). The cylindrical cross-section may be circular, oval, elliptical, square, or have any other geometric cross-section, and preferably a continuous and identical cross-section. The volatile liquid may be an aqueous material or organic material. By volatile, it is meant that the liquid should evaporate at a rate that is no more than 300% slower (one fourth the evaporation rate, four times the length of evaporation) then distilled water in air at 20° C. and 760 mm Hg and 50% relative humidity with an exposed surface area of 100 cm² over a time period of five minutes (the time limitation to assure that the liquid, if there are dissolved materials in it, does not become more concentrated by evaporation and therefore reduce its vapor pressure and decrease its evaporation rate). Organic materials could include any organic liquid, such as alcohols, ketones, hydrocarbons, organic amines, and the like, with acceptable volatility levels. Preferred materials, because of their availability, low cost and lower toxicity are alcohols, particularly alcohols with 6, 5, or 4 and fewer carbons, such as methanol, ethanol, propanol, isopropanol, butanol and the like. The method of applying the electrically heated grip to a cylindrical support comprising applying a volatile liquid between the inner surface and the cylindrical support, sliding the grip onto the cylindrical support by a first force, and evaporating said volatile liquid so that the grip cannot be slid off the cylindrical support except at least by a second force that is 20 kg greater then the first force. The cylindrical support may be any structural material, such as metals, metal oxides, polymers, ceramics, composites, and the like.

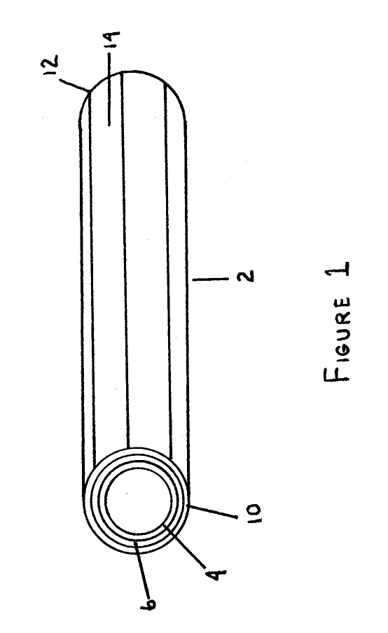

FIG. 1 shows a perspective view of a cross-section of a two layer cover element 2 of the present invention with an overlain resist heating layer 10 with embedded leads 12 therein. The two layer cover element 2 comprises an innermost layer 4 comprising the layer with a Shore Hardness A value of less then 55 is contiguous with an outer cover layer 6 of the at least two layer construction 2. The outer cover layer 6 has a Shore A hardness of at least 65. The third and outermost layer in this preferred construction comprises the resist heating layer 10 shown with the electrical leads 12 that power the resistive heating. The leads 12 themselves may be resistive elements that are hated by current passing through them and which heat is partially insulated or mildly conducted by intervening polymeric material 14, or where the leads establish a voltage between adjacent positive/negative configurations of electrodes, and the intervening material 14 is resistive and generates heat by current passing between the electrodes and through the intervening material 14. Examples of intervening material are polymers having an inherent controlled conductivity (as by the percentage of quaternary groups or other electrically conductive groups present/molecular weight) or by controlled loading of the polymer with conductive materials (e.g., carbon black, metal particles, metal-plated particles and the like, including nanoparticle size conductive filler).

These and other aspects of the invention have obvious variations that can be practiced and understood by one skilled in the art as within the broad scope of the teachings of the invention. The examples given above are intended to be exemplary of the broad scope of the invention and are not intended to perform as absolute limits on the scope of the invention.

What is claimed:

1. A method of applying a cover element to an elongated support having a uniform cross-section, the method comprising sliding the cover element over the elongated support by force, the cover element having an interior surface on at least one layer facing and adjacent to the elongated support, the interior surface having a Shore A hardness of less then 55.

2. The method of claim 1 wherein the cover element comprises at least two layers, the at least one layer and an adjacent layer secured to the at least one layer, the adjacent layer having a Shore A hardness of at least 65.

3. The method of claim 1 wherein the elongated support comprises a metal support.

4. The method of claim 2 wherein the elongated support comprises a metal support.

5. The method of claim 4 wherein the metal support comprises a cylindrical cross-section tube.

6. The method of claim 5 wherein the tube comprises a handle or grip.

7. The method of claim 2 wherein a volatile liquid is placed between the cover element and the elongated support during sliding.

8. The method of claim 1 wherein a force needed to remove the cover element after it has been applied to the elongated support for at least 4 hours at 20° C. and 50% relative humidity is at least four times grater then the force used to slide the cover element over the elongated support.

9. The method of claim 2 wherein a force needed to remove the cover element after it has been applied to the elongated support for at least 4 hours at 20° C. and 50% relative humidity is at least four times grater then the force used to slide the cover element over the elongated support.

10. The method of claim 5 wherein a force needed to remove the cover element after it has been applied to the elongated support for at least 4 hours at 20° C. and 50% relative humidity is at least four times grater then the force used to slide the cover element over the elongated support.

11. The method of claim 8 wherein a volatile liquid is placed between the cover element and the elongated support during sliding.

12. The method of claim 10 wherein a volatile liquid is placed between the cover element and the elongated support during sliding.

13. The method of claim 2 wherein the layer having a surface with a Shore A hardness of less then 55 comprises a polymer selected from the group consisting of polyesters, polyolefins, polysilicone resins, polyamides, polyvinyl resins, polyurethanes, polycarbonates, and polysulfones.

14. The method of claim 2 wherein a resist heating cover is placed over the layer with a Shore A hardness of at least 65.

15. The method of claim 5 wherein a resist heating cover is placed over the layer with a Shore A hardness of at least 65.

16. The method of claim 10 wherein a resist heating cover is placed over the layer with a Shore A hardness of at least 65.

17. The method of claim 12 wherein a resist heating cover is placed over the layer with a Shore A hardness of at least 65.

18. An elongated support having an at least dual layer cover over at least a portion of an outer surface of the elongated support, the at least dual layer cover comprising a first polymeric layer in non-adhesive contact with the outer surface of the elongated support, the first polymeric layer having a Shore A hardness of less then 55, and a second polymer layer of the at least dual layer construction comprising a polymer having a Shore A hardness of at least 65 adjacent to the first polymeric layer and secured thereto.

19. The support of claim 18 wherein a resist heating element is secured to an exterior surface of the second polymer layer.

20. The support of claim 19 wherein the elongated support comprises a handle of metal.
